(19) United States
(12) Patent Application Publication
(10) Pub. No.: US 2008/0038660 A1
(43) Pub. Date: Feb. 14, 2008

(54) Method Of Making Grating Structures Having High Aspect Ratio

(76) Inventors: Sergio Doneda, Bresca (IT); Romano Morson, Milano (IT); Stefano Sardo, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/579,167

(22) PCT Filed: May 21, 2004
(86) PCT No.: PCT/EP04/05505

§ 371 Date: Jul. 24, 2007

(51) Int. Cl. G02B 5/18; G02B 6/12; G02B 6/34

(52) U.S. Cl. 430/270.1; 216/38; 430/296

(57) ABSTRACT

A method for realizing a grating structure including the steps of providing a layered structure having a substrate, a grating layer, a first masking layer of polysilicon, a dielectric layer and a second masking layer. Additionally, a resist layer is deposited on the second masking layer; the resist layer is exposed according to a selected pattern to an electron beam; the resist layer is developed according to the pattern; the second masking layer is etched using the developed resist layer as a mask to form a patterned second masking layer; the dielectric layer is etched using the patterned second masking layer as a hard mask to form a patterned dielectric layer; the first masking layer is etched using the patterned dielectric layer as a hard mask to form a patterned first masking layer; and the grating layer is etched using the patterned first masking layer as a hard mask to form the grating structure.

### TECHNICAL FIELD

The present invention relates to a method of making grating structures, in particular structures having a high aspect ratio.

Additionally, the invention concerns a method to reduce the roughness of a polysilicon layer.

### TECHNOLOGICAL BACKGROUND

Optical apparatus employing wavelength selective devices such as gratings are of critical importance to the fiber optic telecommunications field.

The term grating is used to describe almost any device whose operation involves interference among multiple optical signals originating from a single source but with different relative phase shifts. Indeed, gratings have been used for many years to separate light into its constituent wavelengths. In WDM systems, gratings are used as demultiplexers to separate the individual wavelengths or as multiplexers to combine them. Many other applications are possible.

The optical properties of the grating, i.e. the amount of light diffracted by it and the efficiency of diffraction, depends, among others, on the physical characteristics of the grating itself. As a possible configuration, a grating is formed by a multiple narrow slits which are spaced apart on a plane, which is called the grating plane. The spacing between two adjacent slits is called the pitch of the grating, while the ratio between the depth of the slits and their width (in the direction of light propagation) is known as the aspect ratio. All these values are selected according to the purpose for which the device, in which the grating is integrated, is realized.

In order to realize a grating in a given material, it is known—for example‘to transfer the grating pattern from a mask (if needed) to a resist covering the given material via a lithographic process. The exposed resist is then removed and the remaining resist is used as an etching mask to protect the portions of the material not to be etched during the etching phase.

Among all gratings of different properties, those having a high aspect ratio, i.e. not smaller than 10:1, are particularly important in WDM or DWDM filters due to their high wavelength selectivity. However, for the fabrication of such gratings, in particular in case of grating in which the width of the slits is smaller than 1 μm, several technological requirements should be achieved in the process of gratings fabrication above outlined, such as high etching rates, good profile control, high selectivity, i.e. high etching rate ratio between the two materials forming the masking layer and the layer to be etched, and acceptable non-uniformity.

Regarding the requirement of obtaining high-resolution patterns, electron beam lithography (EBL) may be used as it offers flexibility and maximum resolution, which are generally larger than those offered by optical lithography. Additionally, there is no need of phase mask. However, charging effects of an insulator surface under electron beam irradiation are known to occur. If the electron beam irradiates directly a resist deposited over a dielectric material, such as SiO₂, it results in a physical restructuring and charge injection in the latter material, thereby creating defects in the material that has undergone etching. A characterization of this effect can be found, as an example, in “Characterisation of electron beam induced modification of thermally grown SiO₂” published in Appl. Phys. Lett. 67 (11), September 1995, pages 1538-1540.

A method of etching the surface of a silica glass substrate for fabricating a phase mask is described in EP patent application No. 0984328 in the name of CSELT Centro Studi e Laboratori Telecomunicazioni S.p.A., wherein a layer of conductive material is deposited on the silica glass substrate and a pattern reproducing the etching pattern to be fabricated is formed on such a conductive material. The deposition of a conductive layer, preferably titanium, on the substrate is designed to prevent surface charge effects, in particular those caused by the electron beam used in the EBL technique.

Additionally, due to the above mentioned charging effects, the resist is exposed to a higher effective amount of radiation during the EBL, and thus the grating dimensions become extremely difficult to control.

To deeply etch a material, an appropriate mask capable to protect the underlying material during the whole etching process should be used. Generally, a deep etching process needs a thick mask with specific characteristics. Therefore a single layer of resist patterned by the e-beam is often not suitable as a mask to deeply etch the underlying material, but an additional masking layer may be inserted between the material to be etched and the resist. Two etching phases then follow, one to etch the masking layer and a second to etch the selected material and form the grating.

Possible etching masks that offer a high selectivity on silica are metal masks, however, these masks have the drawback of possibly introducing cross-contaminations. Metal masks are to be avoided particularly when it is desirable to obtain compatibility with processes of semiconductor devices production, in which only extremely low metal contaminations are tolerated. Therefore, a careful selection of the masking layer material is extremely important to obtain the desired results,

A possible method for realizing high-aspect ratio grating structures using photolithographic methods is disclosed in the International Patent Application n. WO 02/086560 in the name of Ibsen Phototonic. In this application, high aspect ratio grating structures are formed by aligning grating structures realized in two different pieces of substrate. Alternatively, high aspect ratio structures can be formed in a single substrate: on a suitable material, on which the grating is to be realized, a masking layer is disposed (the masking layer can be made of metals, alloys or metal mixtures; suicides; silicon; diamond; etc). A photoresist layer is then formed over the masking layer. In order to form the grating, the photoresist layer is exposed to light, developed, and then the masking layer is etched. The substrate is then etched using the patterned masking layer as a mask using a deep reactive ion etching (DRIE) technique.

Applicants have observed that optical lithography allows the patterning of sub-micrometric structures only by using thin resist layers, which are not suitable for deep etching in which a resist layer of several hundreds of nm is generally needed in order to protect the underlying layer during the whole etching process. Additionally the equipment necessary for sub-micron optical lithography is extremely expensive, more than the one needed for e-beam lithography.

A method of forming a deeply etched grating is described in “Highly compact, low loss silica based 2DIO wavelength filter for WDM datacommunications networks”, published in the Proceedings of the 27^{th} Conference on Optical Communication (2001), vol. 6, p. 26-7. A deeply etched grating is realized on a silica-on-silica slab structure on which a metal etch mask is deposited. The mask is patterned in one photolithographic exposure and then the grating is etched into the slab structure using an anisotropic low power reactive ion etching (RIE) process with a CFC/oxygen/inert gas mixtures to a depth of >8 μm.

As remarked above, metal masks often produce cross-contamination effects. Applicants have noted that another possible side effect of metal masks is the possibility of residues, at the end of the process, of metal contaminants inside the slits, contaminants that may alter the optical properties of the grating structure.

In “Inductively coupled plasma etching for arrayed waveguide gratings fabrication in silica on silicon technology”, published in J. Vac. Sci. Technol. B 20(5), pages 2085-2090, a method to fabricate arrayed gratings in silica on silicon is disclosed. Waveguides are formed depositing a layer of undoped silicon dioxide for the lower cladding, a layer of phosphorous doped silicon dioxide for the core and a layer of boron and phosphorous doped silicon dioxide for the upper cladding. The mask selected for the lithography is a photoresist mask, which is deposited on the wafer by spinning. Plasma etching of the silicon dioxide is performed, in particular a reactive ion etching with a C₄F₈/O He gas mixture. The obtained aspect ratio is higher than 3:1, the depth of the trenches is greater than 15 μm and their width ranges between 4 and 10 μm.

In the International applications WO No. 2004/029681 and WO No. 2004/029682 a high aspect ratio Bragg grating is disclosed. With reference to FIG. 5 of these applications, a grating structure having slits with width of 500 nm is described. This grating is realized on a waveguide, part of a multiplexer/demultiplexer adapted to the use in wavelength division multiplexing optical communications.

In the lithography processes, it is preferable that the layer deposited underneath the resist is as flat as possible, i.e., with a low surface roughness. In fact, a high roughness of the layer surface on which the resist is formed is often responsible of a decrease in the pattern resolution, particularly when sub-micron structures are desired. In these cases, tolerances are extremely modest and therefore the amount of roughness present in the layer to be patterned becomes critical. Due to surface roughness, the desired pattern can not be projected onto a defined plane and scattering might occur, thereby limiting the accuracy of patterning the resist.

A method to reduce the surface roughness of a polysilicon layer has been disclosed in U.S. Pat. No. 6,503,848 in the name of Taiwan Semiconductor Manufacturing Company. A polysilicon layer is deposited over a silicon substrate. In order to form a smooth top surface on the layer of polysilicon, a layer of polymer is deposited on the layer of polysilicon using chemical vapour deposition. The top surface of the layer of polymer must be at a critical distance above all peaks of the layer of polysilicon. The layer of polymer and part of the layer of polysilicon is then etched using an etching method in which the ratio between the etch rate of the polymer and the etch rate of the polysilicon is around 1.0. This leaves a smooth top surface on the layer of polysilicon. In U.S. Pat. No. 5,937,275 in the name of Robert Bosch GmbH, a method for eliminating the surface roughness of a polysilicon layer is used. On the surface of a polysilicon layer, a photoresist layer is applied. A plasma etching step is then performed, and for this plasma etching step the etching parameters are selected such that the polysilicon and photoresist are etched at the same etching rates. Additionally, a second etching process can be performed: after the first etching phase above described, the polysilicon layer, which still presents a residual waviness, is again covered by a photoresist layer. Then an etching step ensues, the etching parameters being selected such that the polysilicon and photoresist are etched at the same etching rates.

Applicants have noted that this method is not suitable for the smoothing of a thin polysilicon layer due to the selected gas mixture (SF₆ and O₂), which is extremely reactive.

### SUMMARY OF THE INVENTION

Applicants have focused attention on grating structures made by e-beam lithography, said structures having widths of less than a micron.

The present invention relates to a method of making grating structures having high aspect ratio, i.e., not smaller than 10:1. In particular, the gratings realized with the method of the present invention present slits which are deep (i.e. deeper than about 5 μm) and have a small width, i.e. lower than 1 μm.

Hereafter, the layer or layers in which the grating is to be realized or has been realized will be generally referred to as the grating layer. As an example, the grating layer can be a waveguide layer.

Preferably, these gratings are realized on silicon-based materials, such as silicon dioxide, which form a waveguide. The waveguide generally comprises layers of different materials, wherein in this context different materials comprise also materials having the same matrix elements, but they are differently doped, such as undoped SiO₂ and Ge-doped SiO₂. The waveguide layers are generally deposited or grown on a suitable substrate.

In order to achieve the needed resolution, according to the method of the invention, an electron-beam patterning is used. However, due to the relatively large depth of the slits to be created (often deeper than about 10 μm), the resists generally used in electron-beam lithography are not suitable to be used as masks in the subsequent etching process.

Therefore according to the method of the invention, a masking layer comprising relatively thick polysilicon is deposited over the layers to be patterned, e.g., the waveguide (o grating?) layers. This polysilicon layer has to be patterned in order to become a hard mask. Polysilicon has been chosen as a suitable masking layer because it is easily deposited and patterned and it is compatible with processes for the production of semiconductor devices, wherein contamination of the silicon based materials with non-compatible metals, such as those that could be suitable as hard masks, is undesirable.

In order to pattern the polysilicon layer, a resist layer as a mask for e-beam lithography is not suitable due to the relatively large thickness of the polysilicon layer itself, e.g., about 2 μm or larger for etching grating slits of not less than 8-10 μm. The thickness of the resist layer needs to be relatively high, e.g., of several hundreds of nm, in order to protect the not-to-be-etched polysilicon during the etching process and, especially in case of patterned slits formed in the resist during the EBL with sub-micrometer width, the risk of a mechanical collapse of the patterned slits in the resist is significant due to their depth. Therefore, according to the method of the invention, an additional hard mask, selective on polysilicon, has to be inserted between the first polysilicon masking layer and the resist layer in order to pattern the polysilicon layer. For this purpose, a dielectric layer is deposited over the polysilicon layer. Preferably, the dielectric layer comprises silicon dioxide.

In turn, the dielectric layer, has to be patterned. The direct patterning of a resist deposited over a dielectric layer causes physical changes (defects) in the dielectric layer itself and, as said above, hinders the control of the realization of sub-micron patterning. This is avoided by the method of the invention by the addition of a thin additional masking layer, preferably comprising polysilicon, on top of the dielectric layer.

The realized layered structure is thus covered by a standard resist used for e-beam lithography.

According to the method of the invention, the resist is patterned and developed. The remaining portions of the resist layer are used as a mask during a first etching phase of the thin layer of polysilicon. The patterned thin polysilicon layer is then used as a hard mask in order to pattern the underlying dielectric layer by a second etching phase.

At this stage, the patterned dielectric layer is used as a hard mask for a third etching phase in which the thick polysilicon layer is patterned.

After having realized a thick hard mask made of polysilicon on top of the waveguide layers, a fourth etching step is used to etch the waveguide layer(s) and to realize the desired grating structure in the waveguide.

Preferably, an additional step is undertaken according to the method of the invention, in order to remove the remaining polysilicon portion of the thick original polysilicon layer from the waveguide layer surface.

According to a preferred embodiment, between the etching phase of the dielectric layer and the etching phase of the thick polysilicon layer, a step of removal of the residual resist is performed.

Applicants have noted that the proper choice of hard masks, the selection of conditions of e-beam lithography and the proposed sequence of etching phases allow the achievement of grating structures having high aspect ratio, higher than 15:1, preferably of the order of 20:1 or above, and with slits deeper than 3 μm and having width smaller than 1 μm, preferably smaller than 0.75 μm.

Applicants found that precise grating structures with sub-micron widths can be achieved by reducing the surface roughness of the masking layer before the deposition of the resist which has to be patterned by the e-beam.

According to another aspect of the invention, in order to obtain a high resolution of the patterned lines, a smoothing phase of the thin polysilicon layer, which is deposited on top of the dielectric layer, is carried out.

According to this smoothing phase, before the deposition of the resist over the thin polysilicon layer, a thin film of photoresist is deposited on top of the thin polysilicon layer, the thickness of the photoresist layer being lower than the higher “peaks” of the thin polysilicon surface due to its roughness. For example, the roughness of the thin polysilicon layer itself is measured and the thickness of the photoresist layer is selected smaller than the maximum measured roughness.

The polysilicon layer, or better the peaks of polysilicon emerging from the photoresist layer, is then etched via an etching process in which the etching parameters are set in such a way that the etching rate of the polysilicon is higher than the etching rate of the photoresist. In this way, the photoresist layer still protects the underlying thin polysilicon layer and only the peaks are removed, avoiding excessive etching of the thin polysilicon layer itself.

Preferably, a second etching step follows the etching step mentioned above. In this step the photoresist is etched and reduces accordingly its thickness, therefore regions of the polysilicon surfaces than were covered by it emerge progressively and are etched in turn.

In this second etching phase, a further smoothing of the thin polysilicon layer is performed, etching the polysilicon peaks that progressively emerge.

It is noteworthy that the problem of roughness reduction arises also in the case of the thick (not smaller than about 2 μm) polysilicon layer deposited over the layers where the grating structure is to be formed, e.g., the waveguide layer. However, this thick poly-Si layer can be smoothed by means of a standard Chemical Mechanical Polishing (CMP) process because the thickness of the layer allows the usage of a smoothing method that removes a relatively large amount of material. In the case of a thin polysilicon layer, i.e., not more than 1 μm, a CMP process would be not suitable because it would remove a too large amount of material, thereby damaging the thin layer itself.

Therefore, in a preferred embodiment, the thick poly-Si layer is polished by CMP before deposition of the hard mask selective on poly-Si.

Applicants have found that the final roughness of the thin polysilicon layer is significantly lower than the initial one.

Additionally, the method of roughness reduction of the invention is suitable for reducing the roughness of relatively thin polysilicon layers, i.e., with thickness not larger than about 1 μm.

The method of the present invention is particularly suitable to form grating structures in integrated optical devices particularly suitable for WDM optical communications. Another suitable application is to make grating structures for the fabrication of photonic crystals formed on silicon based materials.

### BRIEF DESCRIPTION OF THE DRAWINGS

Further features and advantages of the method of making grating structures, in particular structures having a high aspect ratio according to the invention and of the method to reduce the roughness of a polysilicon layer will become more clearly apparent from the following detailed description thereof, given with reference to the accompanying drawings, where:

FIGS. 1a-1g are schematic cross-sectional side views illustrating phases of the method of making grating structures according to the invention;

FIG. 2 is a graph showing the measurements of initial roughness of the polysilicon layer employed in the method according to the invention;

FIGS. 3a-3d are schematic cross-sectional side views illustrating phases of the method for reducing the roughness of the polysilicon layer, whose initial roughness is plotted in FIG. 2, in order to make grating structures according to the invention;

FIG. 4 is a graph showing the comparison between the initial and the final roughness of the polysilicon layer employed in the method according to the invention;

FIG. 5 is a SEM cross-sectional side view of the polysilicon layer after the method for reducing its roughness according to the invention.

### PREFERRED EMBODIMENTS OF THE INVENTION

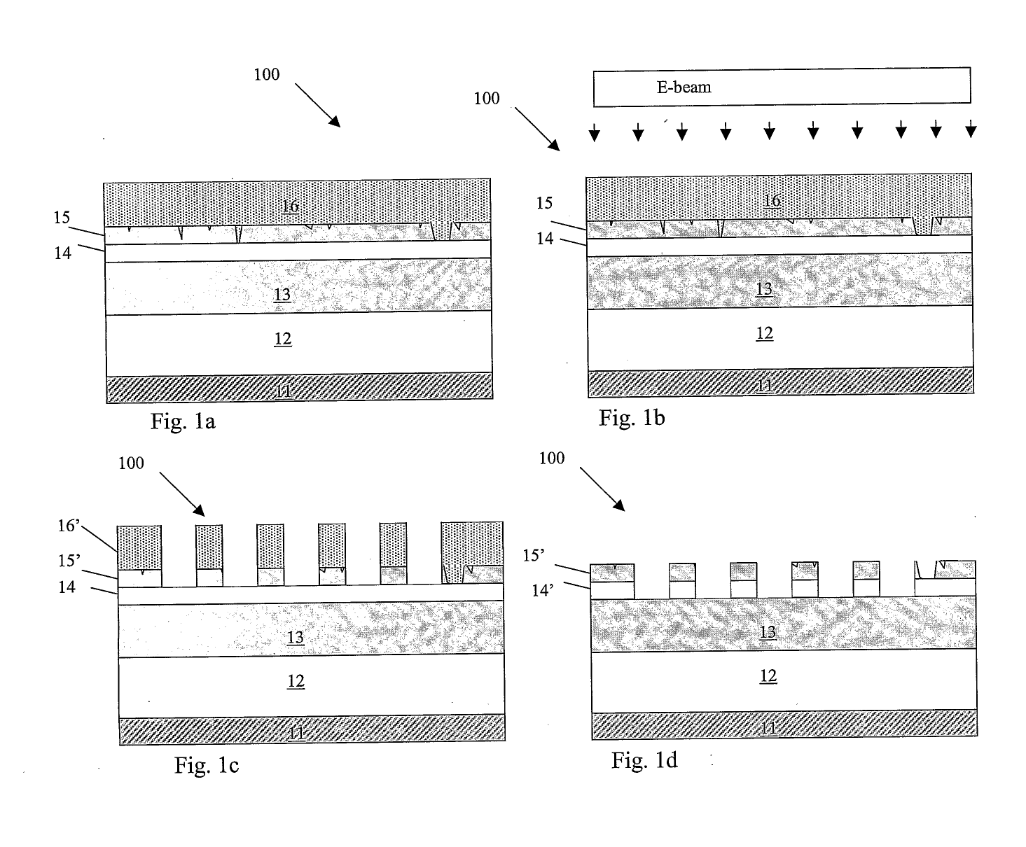

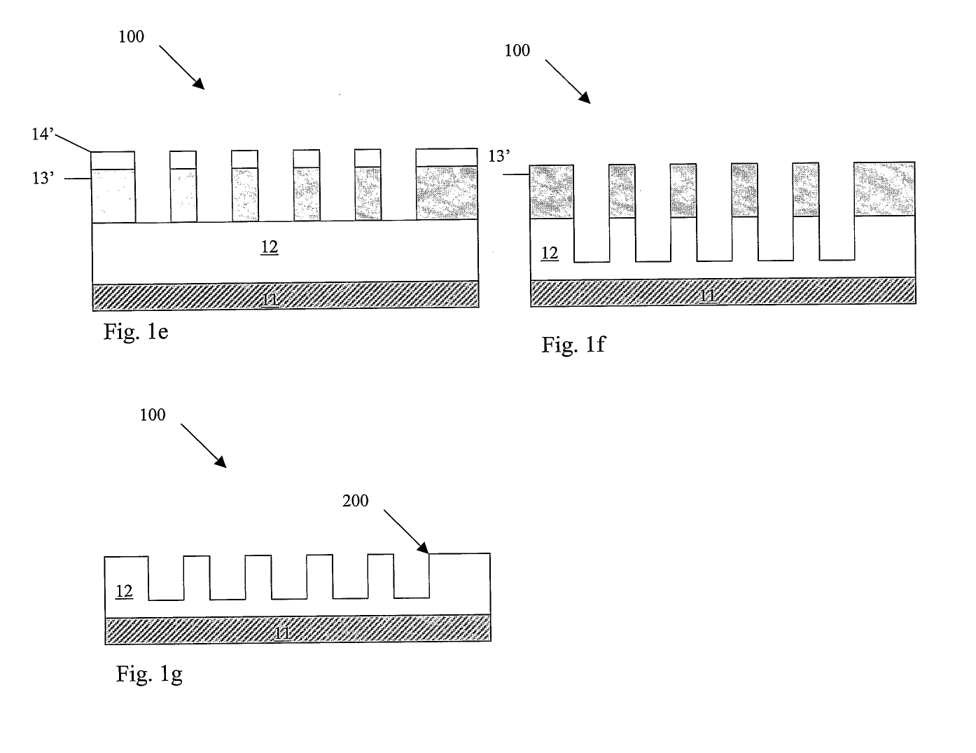

With initial reference to FIGS. 1a-1g, 100 indicates a layered structure on at least a layer of which a grating structure 200 is formed according to the method of the present invention.

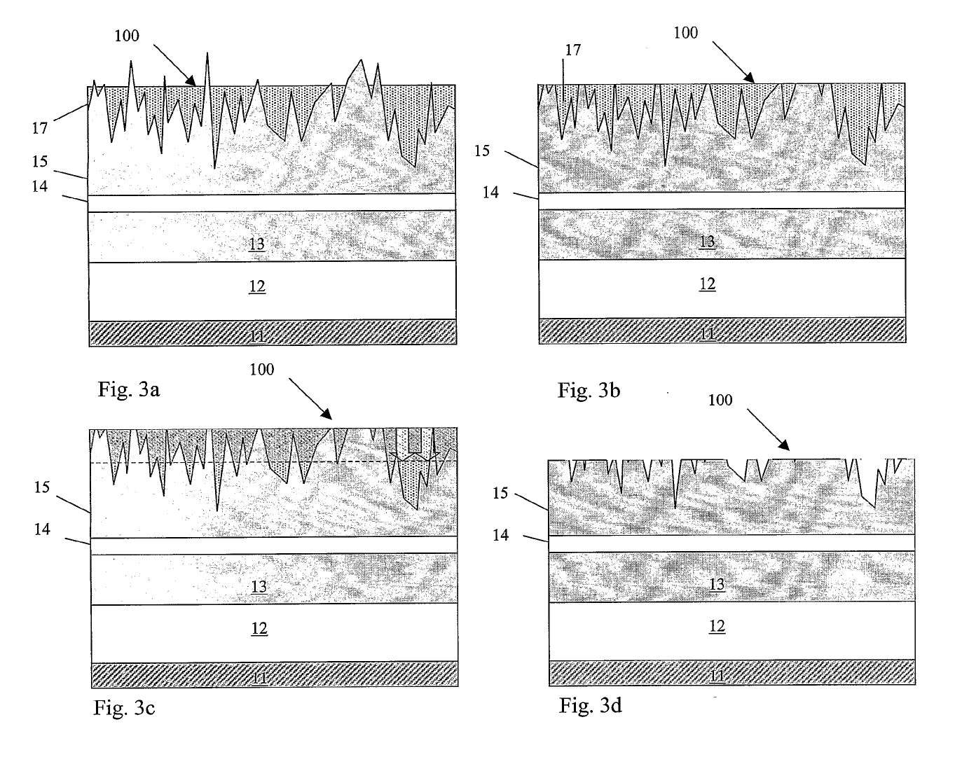

It is understood that the FIGS. 1a-1g and 3a-3d are not drawn to scale.

A grating structure may be defined as a longitudinal variation in refractive index in an optical substrate arrangement, e.g., a waveguide (or fiber). The performance of a grating structure depends on a plurality of parameters such as the grating pitch, which is the distance between two adjacent longitudinal variations, e.g., between “vertical cavities” called slits, the depth and the width of the slits.

In the context of this description, “grating structure” or “final grating structure” refers to the grating produced by the described method of the invention. However the grating so realized may still undergo other additional changes not described in the present document.

The grating may be realized in one or more layers, called in the present context “grating layers”. For example, these grating layers will eventually lead to the final waveguide structure.

The layered structure 100 is realized on a substrate 11, for example a silicon wafer, and it comprises a grating layer 12, a first masking layer 13, a dielectric layer 14 and a second masking layer 15, vertically stacked one on top of the other (“vertical” indicates the orientation perpendicular to the layers in the referred drawings, even if the physical orientation may be different).

The substrate 11 may comprise a silicon based material, such as Si, SiO₂, doped-SiO₂, SiON and the like. Other conventional substrates will become apparent to those of ordinary skill in the art given the present description.

The grating layer 12, which is in a preferred embodiment a waveguide layer, on which the grating structure 200 will be realized according to the method of the invention, is preferably fabricated from semiconductor materials, such as doped or non-doped silicon based materials and other conventional materials used for waveguides. Although we refer to a single waveguide layer, it is to be understood that such a waveguide layer can in fact comprise more layers of different or same materials, for instance a bottom cladding layer, a core layer and a top cladding layer, stacked on top of each other. For example, in a preferred embodiment of the invention, the waveguide layer 12 comprises a bottom cladding layer made of undoped SiO₂ layer, a core layer made of Ge-doped SiO₂ layer and a top cladding layer made of undoped SiO₂. The top cladding layer may alternatively be doped or undoped, for example can be realized in undoped silica glass. It is understood that other materials may be employed as known by those skilled in the art. For instance, the core layer could be made of Si₃N₄.

The waveguide layer 12 is deposited or grown on the silicon substrate 11 by conventional deposition techniques. The thickness of this layer is preferably of about few tens of micron, more preferably of about 25-30 μm. The top cladding layer and the bottom cladding layer are preferably of the order of 10 μm each, while the core has a thickness of a few μm, e.g., 4-5 μm. In any case the depth of the slits of the grating structure 200 (FIG. 1g), which has to be realized may be lower than the thickness of the waveguide layer 12.

Due to the relatively large depth of the slits, e.g., more than 10 μm, it is necessary to select a hard mask covering the waveguide layer 12 sufficiently resistant to the etchant used to form the grating structure, so that the portions of waveguide layer 12 covered by the hard mask are not substantially etched. The thickness of this hard mask depends on the depth of the slits to be formed (i.e. the deeper the slits, the longer the exposition to the etchant), on its resistance to the etchant used and on the technique used to for the masking layer itself.

According to the method of the invention, a polysilicon mask has been chosen as a suitable hard mask to protect the waveguide layer 12. Thus, the first masking layer 13, which is deposited on top of the waveguide layer 12 and is to be patterned as described in the following, comprises polysilicon. The term “polysilicon” stands for polycrystalline silicon (also referred to as poly-Si) and the layer 13 is preferably deposited in a Low Pressure Chemical Vapour Deposition (LPCVD) reactor, even if alternative deposition techniques might be used. This material has been selected as hard-mask because can be easily deposited and patterned and has the advantage of being compatible with the processes of semiconductor devices production, which is a relevant factor in reducing costs.

Preferably, the top surface of the first masking layer 13 is polished by CMP.

Preferably, the thickness of the first masking layer 13 is not lower than 4 μm so as to avoid that this layer is completely etched away during the etching process to realize the grating structure 200 on the waveguide layer 12. It is to be understood however that the layer thickness of the poly-Si depends on the depth of the grating slits and on the selectivity of the etching process. Typically, poly-Si mask layers of not less than 2 μm are necessary for etching grating slits of not less than 8-10 μm. In order to pattern the first masking layer 13 to form the mentioned hard mask for the waveguide layer, an additional hard mask is preferably used, instead of a direct patterning of layer 13. Due to the relatively large thickness of the layer 13, a typical resist used as a mask in electron beam lithography exhibits normally a low mechanical resistance for such a deep etching. This further masking layer, which has in turn to be patterned, is a dielectric layer 14 (see FIG. 1a) and it is preferably realized in a silicon-based material, such as SiO₂. However any material different from poly-Si can be used as long as it has a high etching selectivity on the material in which the first masking layer 13 is realized and it is not a metal for the reasons already outlined. Layer 13 can be deposited using Plasma Enhanced Chemical Vapor Deposition (PECVD) or Low Pressure CVD (LPCVD).

The thickness of this dielectric layer 14 is preferably between 100 nm and about 1 μm, the thickness depending on the etching selectivity, on the thickness of the underlying layer and on the etching process conditions.

It is known that when an electron beam irradiates a resist directly deposited over a dielectric material, such as the dielectric layer 14, it results in a formation of defects in the dielectric layer itself. To avoid this inconvenience, a second non-dielectric masking layer 15 is deposited, using for example LPCDV technique, over the dielectric layer 14. This second masking layer 15 is realized preferably in polysilicon as the first masking layer and its thickness is of a fraction of the thickness of the first masking layer 13, more or less of the order of the thickness of the dielectric layer 14. The top layer shown in FIG. 1a and 1b covering the layered structure 100 is a resist layer 16, which comprises a conventional polymer or resist material, such as polymethylmethacrylate (PMMA) or UV6™, made by Shipley, suitable for electron beam lithography. The resist layer is deposited on the layered structure 100 using an appropriate technique such as spin coating.

According to a phase of the method of the invention, the resist layer 16 is patterned by an electron beam (see FIG. 1b), which has a small beam waist in order to obtain the desired narrow lines. The electron beam transfers the desired pattern (the grating lines) onto the resist 16 during the writing process. However, also multiple grating patterns may be defined at the same time. Generally, the desired pattern(s) is (are) created in a file such as a CAD file and written directly on the resist using an appropriate software. In particular, the desired pattern(s) may include parallel lines, in which the center-to-center spacing between the parallel lines is twice the pitch desired in the final grating structure 200. While in this preferred embodiment the pattern includes straight parallel lines with a constant pitch, in other embodiments the pattern may include other configurations of parallel lines, such as concentric circular lines, different pitches in different section of the pattern, etc. For instance, the method of the invention is suitable for the realization of, for example, apodized grating structures as well.

Due to the non-dielectric nature of the second masking layer 15, no defects are created therein by the electron beam patterning.

The electron beam changes the physical and/or chemical characteristics of the resist layer 16, so that exposed and non-exposed portions will respond in a different manner to a subsequent development phase. In case of positive resist, the exposed areas of the layer are removed, while in case of negative resist the exposed areas remain.

The resist layer 16 is thus developed accordingly to resolve the pattern, using a suitable developer. The remaining resist is used as an etching mask 16′ for the following phase of the method of the invention.

According to the invention, a first etching phase follows the resist layer 16 development, in order to transfer the pattern realized on this layer onto the second masking layer 15. This etching phase and all the etching phases described in the following are preferably dry etching phases, which allow a better control on the width and depth of the lines, in particular of narrow lines and deep etching as in this case. The first etching phase of the second masking layer 15 (which now acts as a hard-mask 15′—FIG. 1c) is followed by a second etching phase in which the dielectric layer 14 is etched, thus obtaining a patterned dielectric layer 14′ which is a hard-mask for the underlying layer. The layered structure 100 after these two phases has the configuration shown in FIG. 1d.

The remaining resist 16′, which has been the first mask used to pattern the second masking layer 15, is then removed (FIG. 1d).

The thick first masking layer 13 is then etched using as a mask the patterned dielectric layer 14′, obtaining a thick polysilicon hard mask 13′ (FIG. 1e). During this phase, in the preferred embodiment, the remaining portions of the second masking layer 15′ are also removed, being the dielectric layer 14 and the waveguide layer 12 realized in the same material. In FIG. 1e, the configuration of the layered structure 100 after these etching phases is schematically depicted.

The final grating structure 200 is then realized on the waveguide layer 12 through an etching process which uses the thick polysilicon hard mask 13′ to pattern and protect the waveguide layer 12. During this phase, the patterned dielectric layer 14′ is also removed. The thickness of the polysilicon hard-mask 13′ allows a protection of the waveguide layer during the whole etching process.

At the end of this fourth etching, phase, in which the grating structure 200 has been obtained on the waveguide layer 12, the polysilicon hard mask 13′ is then removed by a wet etching phase.

### EXAMPLE 1

The layered substrate 100 and resist layer 16 are realized as follows:

Resist layer 16: Shipley UV6™ having a thickness of 280 nm.

Second masking layer 15: polysilicon layer, thickness: 1 μm, deposited by LPCVD.

Dielectric layer 14: Layer of SiO₂, thickness: 0.4 μm, deposited by PECVD.

First masking layer 13: polysilicon layer, thickness: 4 μm, deposited by LPCVD.

Waveguide layer 12: a 5-μm thick bottom cladding layer of undoped SiO₂, a 4-μm thick core layer formed on the bottom cladding layer and a top cladding layer of thickness of 10 μm, which is formed on the core layer.

Substrate layer 11: silicon wafer.

To realize the grating structure 200, the following steps of the method of the invention have been undertaken:
1. The first phase requires the patterning of the resist layer 16 by means of a Gaussian electron beam and the development of the exposed resist;
2. The second phase is a dry etching phase of the first polysilicon layer 15 by using an inductively coupled plasma (ICP) source. The gas mixture used is of Ar/SiCl₄/O₂. However also a mixture of SF₆, O₂ and CHF₃ could be used.
3. The dry etching of the dielectric layer 14 is performed by reactive ion etching (RIE) by using a CHF₃/O₂/Ar gas mixture. Alternatively, etching of layer 14 can be carried out with an ICP source using a C₄F₈/O₂/He gas mixture.
4. The removal of the residual resist 16′ is achieved by using an O₂ plasma.
5. The fifth phase comprises a dry etching phase of the thick polysilicon layer 13 with a ICP plasma source using a gas mixture of Ar/SiCl₄/O₂. However also a mixture of SF₆, O₂ and CHF₃ could be for example used.
6. The dry etching of the thick waveguide layer 12 is performed by reactive ion etching (RIE) by using a CHF₃/O₂/Ar gas mixture. Alternatively, etching can be carried out with an ICP source using a C₄F₈/O₂/He gas mixture.
7. The removal of the residual polysilicon is made by a solution of ammonium, tetramethyl hydroxide (TMAH).

The grating structures 200 realized with the method of the invention have a high aspect ratio, preferably not smaller than 10:1 and more preferably not smaller than 20:1, in particular for slits having a width smaller than 500 nm, the preferred aspect ratio is not smaller than 20:1. Additionally the depth of the slits forming the grating structure is preferably above 10 μm and more preferably above 15 μm. Moreover, the width of the slits is lower than 0.75 μm, preferably not larger than 0.5 μm. The method according to the present invention allows the formation of deep trenches also with slit width below 300 nm, e.g., in the range of 150-300 nm. The pitch of the grating is preferably above 1 μm.

According to a further aspect of the present invention, it is preferable to smoothen the top surface of the second masking layer 15 before depositing the resist layer 16 on top of it. When the polysilicon layer 15 is deposited by LPCVD the roughness of its top surface is typically relatively high, around 100 nm, therefore it might be worth reducing it in order to obtain higher precision in the patterning process.

For this purpose, the method of the invention provides a step of roughness reduction of the second masking layer 15, before the deposition of the resist 16.

The roughness reduction step comprises a plurality of sub-steps outlined in the following and schematically depicted in FIGS. 3a to 3d. As a first sub-step, according to the invention, the initial roughness of the polysilicon layer 15 top free surface is evaluated. To perform this operation, a KLA-Tencor P10 surface profiler has been used. This instrument scans the top surface of the second masking layer 15 following a straight path with a needle, and sensing the surface profile with a resolution up to 0.5 Å (0.05 nm) over short scan distances.

From these data, the instrument software obtains the surface average centerplane, and calculates the roughness as the standard deviation (RMS=Root Mean Square or R_{q}; according to the ANSI/ASME standard, the RMS roughness is defined as: R_{q}=

$${( \frac{1}{L} \cdot {\int }_{0}^{L} {y}^{2} ⅆ x )}^{\frac{1}{2}} )$$

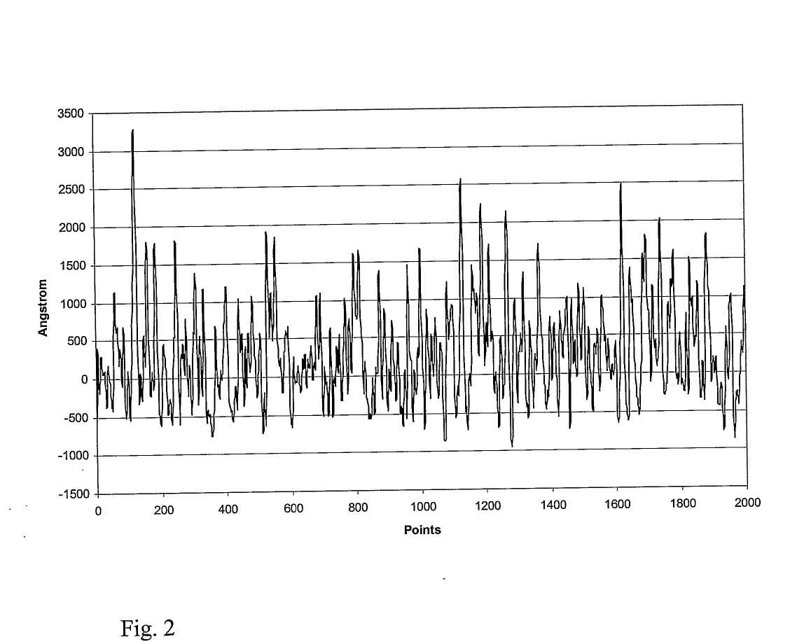

of the surface points from this plane (in the analysis performed by the Applicants, the 3D layer surface topography has been analyzed two-dimensionally. Therefore, instead of the surface centerplane, a 2D centerline has been considered, as the centerplane's cross-section in a certain region of the layered structure 100). As an example, setting the average surface level conventionally at 0, it is possible to measure “peaks” and “valleys” that deviate even few thousands Angstrom from this average. In the graph of FIG. 2, it is represented the measured initial roughness of the top surface of the second masking layer 15 of the layered structure 100 outlined above in the example 1.

After measuring the initial roughness, the next sub-step of the method of the invention comprises the deposition, for example by spinning, of a photoresist (PR) layer 17 on the layered structure 100. The deposition is performed by a spinner, an instrument by which the layered structure 100 is hold horizontally by a rotating vacuum pod and which drops a certain amount of liquid PR, while spinning the structure 100 at the proper speed in order to get the required PR thickness.

The thickness value of the PR layer 17 is low and it can be obtained by using a low viscosity PR solution and spinning it at a high speed. This choice has been made so that the PR layer 17 surface is flat and does not cover the highest peaks on the second masking layer 15 surface (see FIG. 3a in which the PR layer 17 has been deposited on the top surface of the second masking layer 15. The dimensions of the peaks shown in FIGS. 3a-3d are exaggerated for sake of clarity). Therefore the thickness of the PR layer has as an upper limit the roughness of the masking layer 15. The thickness of the PR layer can be selected to be of the order of the RMS roughness that has been calculated. Afterwards, the PR layer 17 is baked to consolidate it and to increase its etch resistance.

According to the method of the invention, the next sub-phase is an etching phase of the new layered structure, which is the combination of the old layered structure 100 plus the PR layer 17. The new structure is loaded into an etcher process chamber (not shown), where dry etch processes can be performed on it. Here the structure is hold by a mechanical clamp onto a metal platen, whose temperature can be controlled and set through a chiller system. Through all the phases in the etcher, the platen temperature is set to a relatively low temperature that preserves properties of the PR layer.

In order to understand how the roughness of the poly-Si is reduced, it is useful to introduce the concepts of “major” and “minor” roughness: “major” stands for those peaks and valleys on the poly surface which give a contribution to the roughness higher than the RMS, whilst “minor” stands for those that give a contribution lower than the RMS.

The roughness reduction method preferably comprises two additional sub-steps, which are performed sequentially in the etching chamber:
1) a first etchback step of the second masking layer 15 that smoothes the polysilicon top surface, reducing its roughness;
2) a second “thinning” step to reduce the PR layer 17 thickness, while etching the second masking layer at the same time.

As shown in FIG. 3a, the top surface of the thin PR layer 17 is much smoother than the underlying top surface of the polysilicon layer 15, therefore it does not cover those peaks of the masking layer 15 which are responsible for the major roughness.

During the first etching step 1), the etching rates are so selected that the peaks in polysilicon material which are not covered by the PR layer 17 are etched, while the PR layer is etched at a much smaller etch rate (ER). Due to this etching rates' difference, the underlying polysilicon layer 15 surface is protected by the PR layer 17, while the highest peaks of polysilicon are completely eliminated, reducing the major contribution to the roughness. The result is a reduction of the average roughness, as shown in FIG. 3b.

The polysilicon layer surface roughness can be measured after this first step, to assess its value and to compare it with the initial one, in order to better understand the mechanism of roughness reduction by etching and to check the amount of polysilicon which has been etched during this step.

Preferably, after the first step above described, a second etching step is performed—step 2)—, in which the PR layer and polysilicon layer etching rates become much lower than in the step 1). While the PR layer 17, which has been already partially etched during the first step 1), is being etched for the second time and its thickness reduced, regions of poly-Si layer surface 15 that were previously covered by it, emerge progressively from the recessing PR layer top surface, and are etched as well (see FIG. 3c). This step is ended when a situation is reached in which the PR layer 17 is almost completely etched; then it is not possible to achieve any further poly layer roughness reduction.

The PR layer 17 residues are then removed by a standard dry and/or wet removal process (see FIG. 3d).

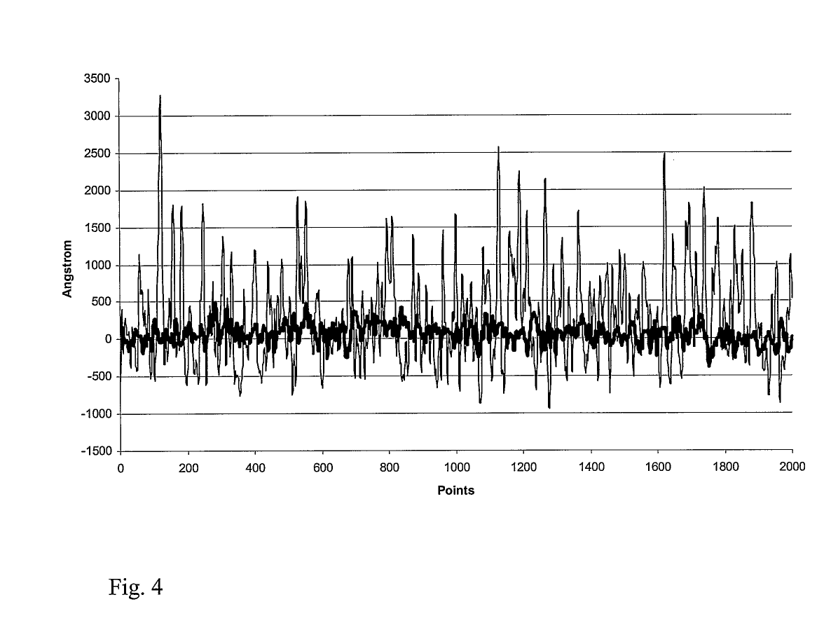

In order to verify the reduction of the roughness of the second masking layer 15, a roughness measurement can be performed according to the method used for the initial roughness measurement above described. As an example, the measurements of the initial roughness of the masking layer 15 and of the residual roughness after the roughness reducing method of the present invention are plotted in FIG. 4: the initial and final surface measurements by the surface profiler are compared (thin solid line versus thick solid line, respectively). It can be seen that there is still a residual roughness, but it is much lower than the original one.

Though the roughness reduction during the step 2 ) is not very high, it is preferred to perform also this second etching step is because it allows to better control both the photoresist and polysilicon etch rates, preserving an adequate poly layer final thickness.

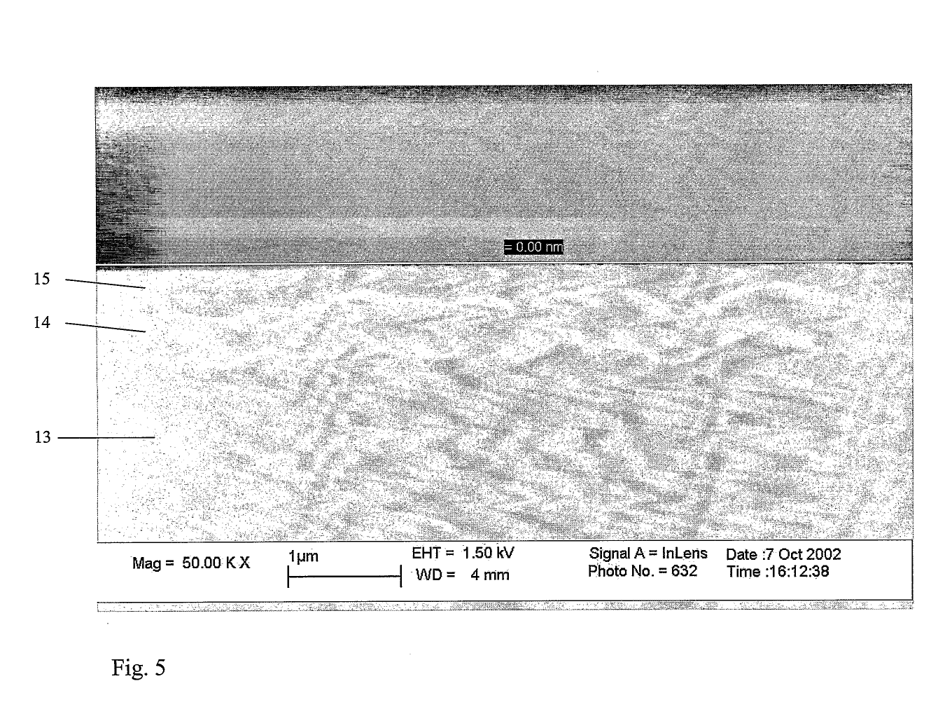

FIG. 5 shows a SEM cross-section of the layered structure 100 after the roughness reduction process.

### EXAMPLE 2

The surface of the second masking layer 15 of the layered structure 100 of example 1 has an initial roughness R_{q} equal to 744 Å (74.4 nm).

The photoresist layer, deposited by spin coating, has a thickness of 280 nm and it is made of commercially available Shipley UV_{6™.}

The PR layer 17 is thus baked at 130° C. for 1 minute.

The first etching step is performed using an inductively coupled plasma source with [20 sccm SiCl₄/ 40 sccm Ar] gas mixture at 10 mTorr chamber pressure, with 300 W Bias power and 260 W ICP power for 3 minutes. The respective calculated etch rates during this first etching step are: ER_{poly}=85 nm/min; ER_{PR}=40 nm/min.

The roughness value obtained after step 1) is R_{q}=112 Å (11.2 nm). This value shows that the roughness has been drastically reduced. Applicants have noted that about 240 nm of poly have been etched and 120 nm of PR have been removed in the process.

In the second etching step, O₂ is added to the SiCl₄/Ar plasma, according to the following recipe: [20 sccm SiCl₄/40 sccm Ar/2.5 sccm O₂] at 50 mTorr chamber pressure, with 300 W Bias power and no ICP power. By setting the ICP power at 0 W, both the PR and poly etching rates become much lower than in the step 1); In fact their value are: ER_{PR}=15 nm/min; ER_{poly}=30 nm/min. The final value of the masking layer 15 surface roughness is: R_{q}=92.6 Å (9.2 nm).

1-34. (canceled)

35. A method for making a grating structure, comprising the following steps:
providing a layered structure comprising a substrate, a grating layer, a first masking layer comprising polysilicon, a dielectric layer and a second masking layer;
depositing a resist layer on the second masking layer;
exposing the resist layer to an electron beam according to a selected pattern;
developing the resist layer according to the pattern;
etching the second masking layer using the developed resist layer as a mask, to form a patterned second masking layer;
etching the dielectric layer using the patterned second masking layer as a hard mask, to form a patterned dielectric layer;
etching the first masking layer using the patterned dielectric layer as a hard mask, to form a patterned first masking layer; and
etching the grating layer using the patterned first masking layer as a hard mask to form the grating structure.

36. The method according to claim 35, wherein said second masking layer comprises polysilicon.

37. The method according to claim 35, comprising the step of removing the remaining portions of said resist layer before etching said first masking layer.

38. The method according to claim 35, comprising the step of removing the remaining portions of said patterned first masking layer after the etching of said grating layer.

39. The method according to claim 35, wherein said grating layer comprises silicon based materials.

40. The method according to claim 35, wherein said dielectric layer comprises silicon dioxide.

41. The method according to claim 35, wherein the grating layer is a waveguide layer.

42. The method according to claim 41, wherein said waveguide layer comprises silicon dioxide.

43. The method according to claim 41, wherein said waveguide layer comprises a bottom cladding layer, a core layer and a top cladding layer.

44. The method according to claim 35, wherein said grating structure comprises a plurality of slits, said slits having a depth of at least 10 μm.

45. The method according to claim 35, wherein said grating structure has an aspect ratio of not less than 10:1.

46. The method according to claim 45, wherein said grating structure has an aspect ratio of not less than 20:1.

47. The method according to claim 35, wherein said grating structure comprises a plurality of slits, said slits having a width not larger than 0.75 μm.

48. The method according to claim 35, wherein the thickness of said first masking layer is 2 to 5 μm.

49. The method according to claim 35, wherein the thickness of said dielectric layer is 100 nm to 1 μm.

50. The method according to claim 35, wherein the thickness of said second masking layer is 100 nm to 1 μm.

51. The method according to claim 35, comprising the step of reducing the roughness of said second masking layer before depositing said resist layer.

52. The method according to claim 51, wherein said step of reducing the roughness of said second masking layer comprises the sub-steps of:
depositing a photoresist layer on said second masking layer so that a top surface of said second masking layer is partially covered by said photoresist layer; and
etching portions of said second masking layer which are not covered by said photoresist layer.

53. The method according to claim 52, wherein in the sub-step of etching the portion of said masking layer, the etching rate of said second masking layer is higher than the etching rate of said photoresist layer.

54. The method according to claim 52, comprising the sub-step of etching said photoresist layer and portions of said second masking layer which progressively emerge from the photoresist layer, after the sub-step of etching the portions of said second masking layer which are not covered by the photoresist layer.

55. The method according to claim 54, wherein in said sub-step of etching said photoresist layer and portions of said second masking layer which progressively emerge from the photoresist layer, the etch rate of said second masking layer is higher than the etch rate of said photoresist layer.

56. The method according to claim 52, comprising the step of removing residues of said photoresist layer.

57. An optical wavelength selective filter comprising a grating structure made according to claim 35.

58. A layered structure, comprising:
a substrate;
a grating layer located on said substrate;
a first masking layer comprising polysilicon located on the grating layer, the thickness of said first masking layer being 2 to 5 μm;
a dielectric layer located on said first masking layer, the thickness of said dielectric layer being 100 nm to 1 μm; and
a second masking layer located on said dielectric layer, the thickness of said second masking layer being 100 nm to 1 μm.

59. The layered structure according to claim 58, wherein said second masking layer comprises polysilicon.

60. The layered structure according to claim 58, comprising a resist layer located on top of said second masking layer.

61. The layered structure according to claim 58, wherein the thickness of said second masking layer is not more than 500 nm.

62. The layered structure according to claim 58, comprising a configuration wherein a grating structure can be formed on at least one of the layers of the layered structures.

63. The layered structure according to claim 58, wherein said grating layer is a waveguide layer.

64. The layered structure according to claim 62, wherein said grating structure has a high aspect ratio.

65. A method for reducing the surface roughness of a polysilicon layer, comprising the steps of:
depositing a photoresist layer over the polysilicon layer so that a top surface of said polysilicon layer is partially covered by said photoresist layer; and
etching portions of said polysilicon layer which are not covered by said photoresist layer, the etch rate of said polysilicon layer being higher than the etch rate of said photoresist layer.

66. The method according to claim 65, wherein the etch rate of the polysilicon is two times or above the etch rate of the photoresist.

67. The method according to claim 65, comprising the step of etching said photoresist layer and portions of said polysilicon layer which progressively emerge from the photoresist layer, after the step of etching the portions of said polysilicon layer which are not covered by the photoresist layer.

68. The method according to claim 67, wherein the etch rate of the polysilicon layer is higher than the etch rate of the photoresist layer.
